(19) United States
(12) Patent Application Publication
(10) Pub. No.: US 2016/0265451 A1
(43) Pub. Date: Sep. 15, 2016

(54) FUEL SUPPLY DEVICE

(71) Applicants: AISAN KOGYO KABUSHIKI KAISHA, Obu-shi (JP); TOYOTA JIDOSHA KABUSHIKI KAISHA, Toyota-shi (JP)

(72) Inventors: Masakazu SUGISHITA, Tokai-shi (JP); Kenji KASASHIMA, Miyoshi-shi (JP)

(73) Assignees: AISAN KOGYO KABUSHIKI KAISHA, Obu-shi (JP); TOYOTA JIDOSHA KABUSHIKI KAISHA, Toyota-shi (JP)

(21) Appl. No.: 15/032,404

(22) PCT Filed: Nov. 19, 2014
(86) PCT No.: PCT/JP2014/080650

§ 371 Date: Apr. 27, 2016

(30) Foreign Application Priority Data
Nov. 28, 2013 (JP) 2013-246591

(51) Int. Cl. F02D 19/06

(52) U.S. Cl. CPC F02D 19/0681; F02D 19/0647

(57) ABSTRACT

A fuel supply device includes: a fuel tank; a fuel supply path through which fuel stored in the fuel tank is supplied; an electric-operated cutoff valve located in the fuel supply path and opened in response to conduction through the cut-off valve; and a controller that controls conduction through the cutoff valve. The controller opens the cutoff valve by conducting an open driving current through the cutoff valve. The open driving current is larger than a holding current of holding the cutoff valve in an open state. Based on a conduction history of the open driving current through the cutoff valve within a retroactive period, the controller implements a process of prohibiting conduction through the cutoff valve.

### TECHNICAL FIELD

This invention relates to a fuel supply device including an electric-operated cutoff valve.

### BACKGROUND ART

Patent document 1 discloses a fuel supply device including an electric-operated cutoff valve provided in a fuel supply path. The fuel supply device of patent document 1 is configured to increase force for driving the cutoff valve by causing a large current to flow through the cutoff valve with the intention of opening the cutoff valve tightly closed with fuel. However, causing the large current to flow continuously through the cutoff valve increases the temperature of the cutoff valve to damage the cutoff valve.

To solve the aforementioned problem, when an internal combustion engine is to be stopped, an ECU in the fuel supply device calculates a period of time from when the cutoff valve is closed to when the internal combustion engine is stopped and stores the calculated period of time. When the internal combustion engine is to be started, the ECU detects the temperature of engine cooling water and the pressure of fuel. Further, based on the period of time spent before the internal combustion engine is stopped and the temperature and the pressure detected when the internal combustion engine is to be started, the ECU calculates a period of time when the large current is to flow to open the cutoff valve. Then, the ECU causes the large current to flow to drive the cutoff valve until the calculated period of time elapses.

An ignition switch may be turned on and off repeatedly when the internal combustion engine is to be started, for example. At this time, the cutoff valve becomes conducting based on each valve-open command and a conduction period is not long. However, issuing the valve-open command repeatedly to the cutoff valve conducts the large current repeatedly through the cutoff valve. As a result, even if a period when the large current is to flow to drive the cutoff valve is limited in the aforementioned manner, the temperature of the cutoff valve increases and thus the cutoff valve may be damaged.

### PRIOR ART DOCUMENT

### Patent Document

Patent document 1: Japanese Laid-Open Patent Publication No. 2000-282928

### SUMMARY OF THE INVENTION

### Problems that the Invention is to Solve

It is an object of this invention to provide a fuel supply device capable of suppressing damage on a cutoff valve even if a valve-open command is issued repeatedly.

### Means for Solving the Problems

To solve the aforementioned problem, a first aspect of this invention provides a fuel supply device including: a fuel tank; a fuel supply path through which fuel stored in the fuel tank is supplied; an electric-operated cutoff valve located in the fuel supply path and opened in response to conduction through the cut-off valve; and a controller that controls conduction through the cutoff valve. The controller opens the cutoff valve by conducting an open driving current through the cutoff valve. The open driving current is larger than a holding current of holding the cutoff valve in an open state. The controller implements a process of prohibiting conduction through the cutoff valve based on a conduction history of the open driving current through the cutoff valve within a retroactive period.

In the aforementioned configuration, conduction through the cutoff valve is prohibited by referring to a plurality of conduction histories of the open driving current within the retroactive period as well as a conduction history of the open driving current in one period. Thus, conduction through the cutoff valve can be prohibited based on conduction histories indicating that the open driving current larger than the holding current was conducted repeatedly. As a result, even if a valve-open command is issued repeatedly, damage on the cutoff valve can be suppressed.

In the aforementioned fuel supply device, the controller preferably starts the process of prohibiting conduction through the cutoff valve on condition that an integrated value of an open driving current conduction period of time within the retroactive period is an upper limit or more.

While the open driving current is conducted, the temperature of the cutoff valve is increased largely. Meanwhile, while the open driving current is not conducted, the temperature of the cutoff valve is unlikely to be increased. Thus, referring to the integrated value of the open driving current conduction period of time within the retroactive period makes it possible to see a proportion of a period when the temperature of the cutoff valve was increased largely and a proportion of a period when the temperature of the cutoff valve was not increased largely within the retroactive period. As a result, the temperature of the cutoff valve can be estimated. If the integrated value is the upper limit or more, the process of prohibiting conduction through the cutoff valve is started. In this way, if the proportion of the period when the temperature of the cutoff valve was increased largely is large, the temperature of the cutoff valve can be estimated to be high. In this case, by starting the process of prohibiting conduction through the cutoff valve, further increase in the temperature of the cutoff valve can be suppressed.

In the aforementioned fuel supply device, the controller preferably starts the process of prohibiting conduction through the cutoff valve on condition that a conduction frequency of the open driving current within the retroactive period is an upper limit frequency of more.

If the open driving current is conducted, the temperature of the cutoff valve is increased largely. Thus, referring to the conduction frequency of the open driving current within the retroactive period makes it possible to see the frequency of occurrence of a situation where the temperature of the cutoff valve can be increased largely within the retroactive period. In this way, the temperature of the cutoff valve can be estimated. Specifically, the situation where the temperature of the cutoff valve can be increased largely is determined to have occurred frequently and the temperature of the cutoff valve can be estimated to be high. Starting the process of prohibiting conduction through the cutoff valve in this case can suppress a further increase in the temperature of the cutoff valve.

In the aforementioned fuel supply device, the controller preferably finishes the process of prohibiting conduction through the cutoff valve on condition that a period when conduction through the cutoff valve is prohibited has continued for a specified period of time or more.

While a non-conduction period continues, the temperature of the cutoff valve is reduced. According to the aforementioned configuration, if a period when conduction is prohibited continues long and the temperature of the cutoff valve is reduced sufficiently, the process of prohibiting conduction through the cutoff valve is finished. Thus, even if conduction through the cutoff valve is prohibited once, the prohibition on the conduction is not removed until the probability of overheating of the cutoff valve is eliminated. Specifically, if the probability of overheating of the cutoff valve is eliminated, the prohibition on the conduction is removed to permit supply of fuel through the fuel supply path where the cutoff valve is located.

In the aforementioned fuel supply device, the fuel supply device is preferably capable of changing fuel to be used. The controller preferably prohibits making a shift to a mode of using fuel to be supplied through the fuel supply path where the cutoff valve is located while conduction through the cutoff valve is prohibited.

While conduction through the cutoff valve is prohibited, a shift may be made to the mode of using the fuel to be supplied through the fuel supply path where the cutoff valve is located while conduction through the cutoff valve is prohibited. In this case, even in the presence of a prohibition on opening of the cutoff valve, a valve-open command directed to the cutoff valve may still be issued. Further, even in the presence of a prohibition on supply of the fuel, a fuel inject command may still be issued. This disables the fuel supply device to operate in a manner responsive to a command to make the operation of the fuel supply device unstable. In this regard, according to the aforementioned configuration, while conduction through the cutoff valve is prohibited, a shift to the mode of using the fuel to be supplied through the fuel supply path where the cutoff valve is located is also prohibited while conduction through the cutoff valve is prohibited. This can make the occurrence of the aforementioned undesirable situation unlikely.

### BRIEF DESCRIPTION OF THE DRAWINGS

FIG. 1 is a schematic configuration view showing an embodiment that embodies a fuel supply device of this invention.

FIG. 2 is a timing diagram showing change in a current valve occurring when a cutoff valve in the fuel supply device is opened.

FIG. 3 is a flowchart showing a conduction prohibiting procedure implemented by a controller of the fuel supply device.

FIG. 4 is a flowchart showing a prohibition removing procedure implemented by the controller of the fuel supply device.

FIG. 5(a) is a timing diagram showing the presence or absence of a valve-open command, FIG. 5(b) is a timing diagram showing the presence or absence of conduction of an open driving current, FIG. 5(c) is a timing diagram showing an integrated value of an open driving current conduction period of time, and FIG. 5(d) is a timing diagram showing the presence or absence of a prohibition on conduction through the cutoff valve.

### MODE FOR CARRYING OUT THE INVENTION

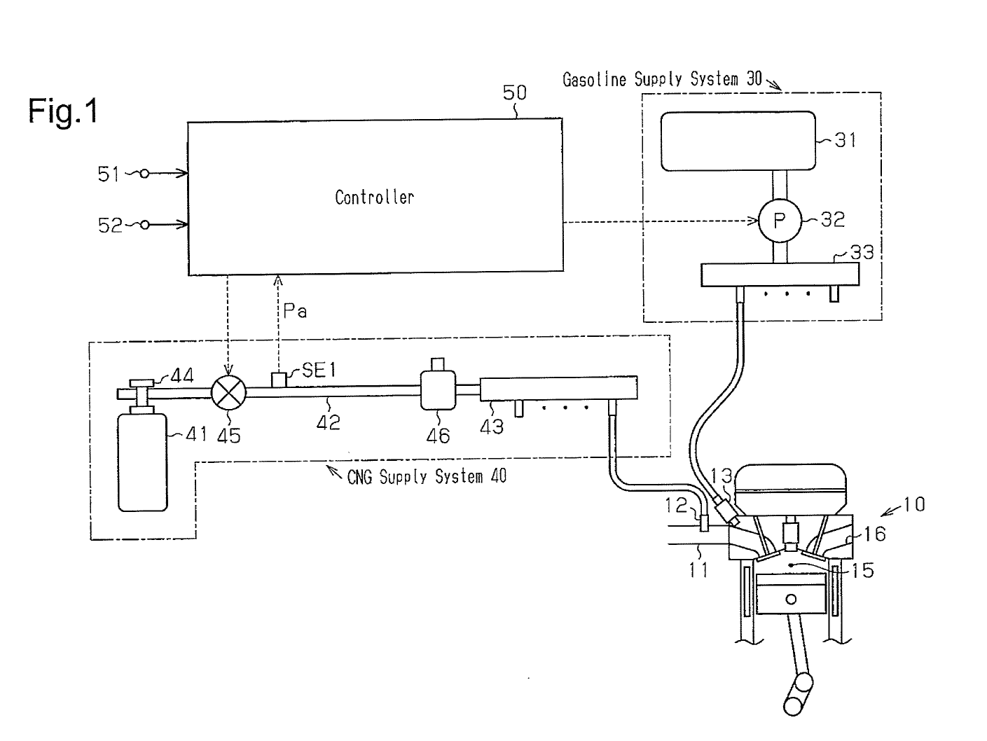

The following describes an embodiment by referring to FIGS. 1 to 5(d) that embodies a fuel supply device as a fuel supply device that supplies fuel to a bi-fuel internal combustion engine to be installed on a vehicle.

As shown in FIG. 1, the fuel supply device includes a CNG (compressed natural gas) supply system 40 and a gasoline supply system 30. An internal combustion engine 10 is a bi-fuel internal combustion engine that selects CNG or gasoline and uses the selected CNG or gasoline.

The internal combustion engine 10 includes an intake path 11 to which a CNG injector 12 and a gasoline injector 13 are attached. In the intake path 11, fuel injected from the CNG injector 12 or the gasoline injector 13 is mixed with intake air to generate an air-fuel mixture. The air-fuel mixture is drawn into a combustion chamber 15 to cause combustion of the air-fuel mixture. After the combustion, the air-fuel mixture becomes an exhaust and is emitted from the combustion chamber 15 through an exhaust path 16.

The internal combustion engine 10 is supplied with gasoline stored in a gasoline tank 31 as a fuel tank and transferred through the gasoline supply system 30. The internal combustion engine 10 is supplied with CNG stored in a CNG tank 41 as a fuel tank and transferred through the CNG supply system 40.

The gasoline supply system 30 includes a fuel pump 32 and a gasoline delivery pipe 33. The fuel pump 32 is used for drawing the gasoline from the gasoline tank 31. The fuel discharged from the fuel pump 32 is transferred under pressure through the gasoline delivery pipe 33. The gasoline delivery pipe 33 is connected to the gasoline injectors 13 of a number the same as the number of cylinders of the internal combustion engine 10. The gasoline supplied through the gasoline delivery pipe 33 is injected from the gasoline injector 13 into the intake path 11.

The CNG supply system 40 includes a high-pressure fuel line 42 as a fuel supply path connected to the CNG tank 41 and a CNG delivery pipe 43. The CNG delivery pipe 43 is connected to a downstream end of the high-pressure fuel line 42, specifically, to the right end thereof in FIG. 1. A manual on-off valve 44 as a hand-operated on-off valve is provided between the CNG tank 41 and the high-pressure fuel line 42. An electric-operated cutoff valve 45 is provided in the high-pressure fuel line 42 in a position downstream from the manual on-off valve 44. The electric-operated cutoff valve 45 is opened and closed by a controller 50 as a controller of the fuel supply device.

If both the manual on-off valve 44 and the cutoff valve 45 are opened, flow of the CNG from the CNG tank 41 into the high-pressure fuel line 42 is permitted. If at least one of the manual on-off valve 44 and the cutoff valve 45 is closed, flow of the CNG from the CNG tank 41 into the high-pressure fuel line 42 is prohibited.

A regulator 46 is provided in the high-pressure fuel line 42 in a position downstream from the cutoff valve 45. The regulator 46 reduces the pressure of the CNG supplied from the CNG tank 41 to a predetermined pressure. After being reduced in pressure to the predetermined pressure, the CNG is supplied into the CNG delivery pipe 43. The CNG delivery pipe 43 is connected to the CNG injectors 12 of a number the same as the number of the cylinders of the internal combustion engine 10. The CNG supplied through the CNG delivery pipe 43 is injected from the CNG injector 12 into the intake path 11.

The CNG supply system 40 includes a pressure sensor SE1 electrically connected to the controller 50. The pressure sensor SE1 detects a pressure Pa in the high-pressure fuel line 42 in a position downstream from the cutoff valve 45.

The controller 50 includes a microcomputer formed of a CPU, a ROM, and a RAM, for example. The controller 50 is connected to an ignition switch 51 and a changeover switch 52 with which fuel to be used is changed to the CNG. The controller 50 uses the CNG and the gasoline separately as fuel to be used for the operation of the engine.

More specifically, if a first mode of making a vehicle travel by the operation of the engine using the gasoline is selected, the controller 50 drives the gasoline supply system 30 to inject the gasoline from the gasoline injector 13. If the first mode is selected, the controller 50 basically closes the cutoff valve 45 in the CNG supply system 40. Meanwhile, if the changeover switch 52 is turned on to allow the vehicle to travel by the operation of the engine using the CNG, the controller 50 shifts a fuel supply mode to a second mode. Then, the controller 50 opens the cutoff valve 45 in the CNG supply system 40 to inject the CNG from the CNG injector 12.

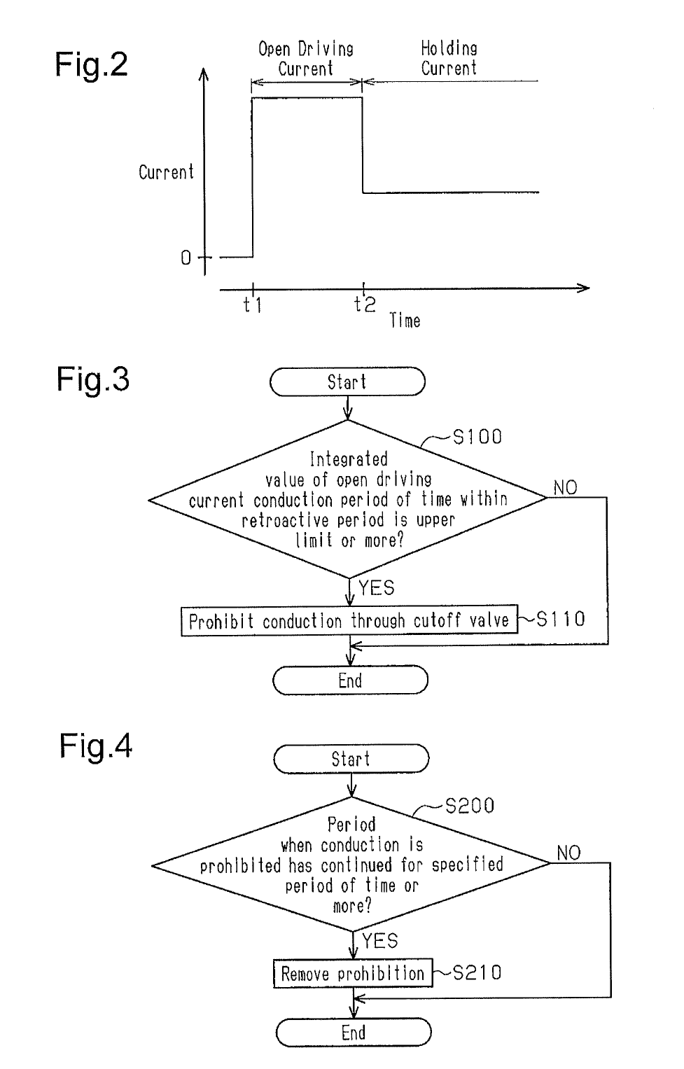

As shown in FIG. 2, to open the cutoff valve 45, the controller 50 causes an open driving current larger than a holding current of holding the cutoff valve 45 in an open state to flow through the cutoff valve 45, thereby applying a large driving force to open the cutoff valve 45. Specifically, when a valve-open command is issued at a time t1, the open driving current is first conducted through the cutoff valve 45. This applies a large driving force to open the cutoff valve 45. Then, after a time t2, the holding current, which is smaller than the open driving current, is conducted through the cutoff valve 45. In this way, the cutoff valve 45 is held open.

As described above, if the second mode is selected, the controller 50 operates the engine using the CNG while placing the cutoff valve 45 in an open state. Meanwhile, even if the ignition switch 51 is turned on and the changeover switch 52 is turned on, the controller 50 still opens and closes the cutoff valve 45 to check the operation of the cutoff valve 45. If the pressure Pa in the high-pressure fuel line 42 is changed as a result of opening and closing of the cutoff valve 45 for this check on the operation, the controller 50 determines that the cutoff valve 45 is operating normally. If a predetermined shift condition is satisfied while the cutoff valve 45 is in a normally operable state and the changeover switch 52 is turned on, the controller 50 shifts the fuel supply mode from the first mode to the second mode. Then, supply of the fuel from the CNG supply system 40 is started.

The ignition switch 51 may be turned on and off repeatedly or the changeover switch 52 may be turned on and off repeatedly to issue a valve-open command repeatedly to the cutoff valve 45. In this case, the cutoff valve 45 becomes conducting based on each valve-open command and a conduction period which is not long. However, the open driving current is conducted repeatedly through the cutoff valve 45. This increases the temperature of the cutoff valve 45, exposing the cutoff valve 45 to a risk of damage. In response, the fuel supply device is configured to temporarily prohibit conduction through the cutoff valve 45 by referring to a conduction history of the open driving current.

Control of prohibiting conduction through the cutoff valve 45 is described next by referring to FIGS. 3 and 4. The controller 50 repeats a series of processes shown in FIG. 3 at a predetermined control frequency while conduction through the cutoff valve 45 is not prohibited.

As shown in FIG. 3, the controller 50 determines in step S100 whether or not an integrated value of an open driving current conduction period of time within a predetermined retroactive period is an upper limit or more. The RAM stores a conduction history of the open driving current. Based on the conduction history stored in the RAM, the controller 50 calculates the integrated value of the open driving current conduction period of time from a preceding point in time separated by the retroactive period. Then, the controller 50 compares the integrated value to the upper limit of this integrated value. To allow the controller 50 to determine that the integrated value being the upper limit or more causes overheating of the cutoff valve 45 before the overheating happens, the upper limit is set based on a result of an experiment conducted in advance.

If the integrated value of the open driving current conduction period of time within the retroactive period is the upper limit or more (step S100: YES), the controller 50 proceeds to a process in step S110. In step S110, the controller 50 starts a conduction prohibiting process of prohibiting conduction through the cutoff valve 45. While the conduction prohibiting process is implemented, the controller 50 does not conduct a current through the cutoff valve 45 even if a valve-open command is issued. Specifically, once the conduction prohibiting process is started through the process in step S110, conduction through the cutoff valve 45 is prohibited. While the conduction prohibiting process is implemented, the controller 50 prohibits a shift of the fuel supply mode from the first mode to the second mode. If the conduction prohibiting process is started to prohibit conduction through the cutoff valve 45, the controller 50 stops this procedure once.

Meanwhile, if the integrated value of the open driving current conduction period of time within the retroactive period is lower than the upper limit (step S100: NO), the controller 50 does not implement the process in step S110 but finishes this procedure once. Specifically, if the integrated value does not reach the upper limit, the conduction prohibiting process is not started. Thus, if the integrated value does not reach the upper limit, the controller 50 conducts the open driving current through the cutoff valve 45 in response to issuance of a valve-open command.

While the conduction prohibiting process is implemented, specifically, while conduction through the cutoff valve 45 is prohibited, the controller 50 repeats a series of processes shown in FIG. 4 at a predetermined control frequency. The procedure shown in FIG. 4 is to remove a prohibition on conduction through the cutoff valve 45.

As shown in FIG. 4, the controller 50 determines in step S200 whether or not a period when conduction through the cutoff valve 45 is prohibited, specifically, a period from when the conduction prohibiting process is started has continued for a specified period of time or more.

If the period when conduction through the cutoff valve 45 is prohibited has continued for the specified period of time or more (step S200: YES), the controller 50 proceeds to a process in step S210.

In step S210, the controller 50 finishes the conduction prohibiting process having been implemented to remove the prohibition on conduction through the cutoff valve 45.

If the period when conduction through the cutoff valve 45 is prohibited is shorter than the specified period of time (step S200: NO), the controller 50 does not implement the process in step S210 but finishes this series of the processes once. Specifically, if the period when conduction is prohibited is shorter than the specified period of time, the conduction prohibiting process is not finished but it continues. In conclusion, the conduction prohibiting process is finished if the period when conduction through the cutoff valve 45 is prohibited has continued for the specified period of time or more.

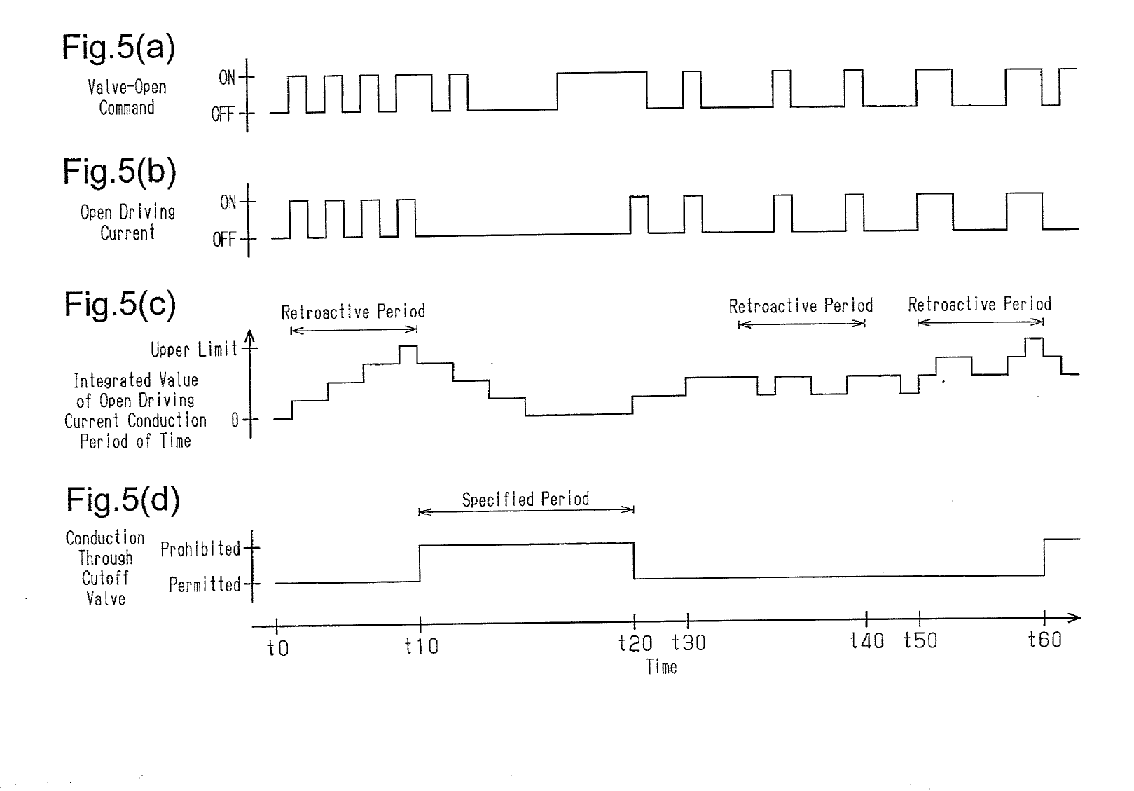

The action of the fuel supply device that implements the conduction prohibiting process is described next by referring to FIGS. 5(a) to 5(d).

As shown in FIG. 5(a), in a period from a time t0 to a time t10, the ignition switch 51 or the changeover switch 52 is turned on and off repeatedly at short intervals. In this period, a valve-open command directed to the cutoff valve 45 is issued repeatedly at short intervals. In this case, as shown in FIG. 5(c), an integrated value of the open driving current conduction period of time within the retroactive period becomes higher with a lapse of time. The integrated value within the retroactive period reaches the upper limit at the time t10. Then, as shown in FIG. 5(d), the conduction prohibiting process is started to prohibit conduction through the cutoff valve 45.

While the conduction prohibiting process is implemented in a period from the time t10 to a time t20, a current is not conducted through the cutoff valve 45 even if a valve-open command is issued as shown in FIG. 5(a). Thus, the open driving current is not conducted as shown in FIG. 5(b).

Next, when the period when conduction is prohibited reaches the specified period of time at the time t20, the conduction prohibiting process is finished as shown in FIG. 5(d). This removes the prohibition on conduction through the cutoff valve 45. If the conduction prohibiting process is finished, conduction through the cutoff valve 45 is permitted. Thus, if a valve-open command is issued as shown in FIG. 5(a), conduction of the open driving current is restarted when the conduction prohibiting process is finished.

Meanwhile, even if the ignition switch 51 or the changeover switch 52 is turned on and off repeatedly, intervals between issuances of a valve-open command may not be short like in a period from a time t30 to a time t40 in FIG. 5(a). In this period, as shown in FIG. 5(c), the integrated value of the open driving current conduction period of time within the retroactive period does not become the upper limit or more. Thus, as shown in FIG. 5(d), conduction through the cutoff valve 45 is not prohibited.

Even though intervals between issuances of a valve-open command may not be short, each valve-open command may be issued for a long duration like in a period from a time t50 to a time t60 in FIG. 5(a). In this period, as shown in FIG. 5(c), the integrated value of the open driving current conduction period of time within the retroactive period reaches the upper limit. Thus, as shown in FIG. 5(d), conduction through the cutoff valve 45 is prohibited (from the time t60).

The embodiment described above achieves the following effects.

(1) Conduction through the cutoff valve 45 is prohibited by referring to a plurality of conduction histories of the open driving current within the retroactive period as well as a conduction history of the open driving current in one period. Specifically, conduction through the cutoff valve 45 can be prohibited based on conduction histories indicating that the open driving current larger than the holding current was conducted repeatedly. Thus, even if a valve-open command is issued repeatedly, damage on the cutoff valve 45 can be suppressed.

(2) While the open driving current is conducted, the temperature of the cutoff valve 45 is increased largely. Meanwhile, while the open driving current is not conducted, the temperature of the cutoff valve 45 is unlikely to be increased. Thus, referring to an integrated value of the open driving current conduction period of time within the retroactive period makes it possible to see a proportion of a period when the temperature of the cutoff valve 45 was increased largely and a proportion of a period when the temperature of the cutoff valve 45 was not increased largely within the retroactive period. As a result, the temperature of the cutoff valve 45 can be estimated. If the integrated value is the upper limit or more, the conduction prohibiting process of prohibiting conduction through the cutoff valve 45 is started. In this way, if the proportion of the period when the temperature of the cutoff valve 45 was increased largely is large so the temperature of the cutoff valve 45 is estimated to be high, the conduction prohibiting process is started. This can suppress a further increase in the temperature of the cutoff valve 45.

(3) While a non-conduction period continues, the temperature of the cutoff valve 45 is reduced. According to the aforementioned configuration, if a period when conduction is prohibited continues long and the temperature of the cutoff valve 45 is reduced sufficiently, the process of prohibiting conduction through the cutoff valve 45 is finished. Thus, even if conduction through the cutoff valve 45 is prohibited once, the prohibition on the conduction is not removed until the probability of overheating of the cutoff valve 45 is eliminated. Specifically, if the probability of overheating of the cutoff valve 45 is eliminated, the prohibition on the conduction is removed to permit supply of the CNG through the high-pressure fuel line 42.

(4) While the conduction prohibiting process is implemented so conduction through the cutoff valve 45 is prohibited, a shift may be made to the second mode of using the CNG. In this case, even in the presence of a prohibition on opening of the cutoff valve 45, a valve-open command directed to the cutoff valve 45 may still be issued. Further, even in the presence of a prohibition on supply of the CNG, a fuel inject command may still be issued to the CNG injector 12. This disables the fuel supply device to operate in a manner responsive to a command to make the operation of the fuel supply device unstable. According to the aforementioned configuration, while the conduction prohibiting process is implemented so conduction through the cutoff valve 45 is prohibited, a shift to the second mode is also prohibited. This can make the occurrence of the aforementioned undesirable situation unlikely.

This embodiment can be changed as follows.

In this embodiment, conduction through the cutoff valve 45 is prohibited based on a conduction history of the open driving current. By doing so, the conduction is prohibited before the cutoff valve 45 is overheated in consideration of effect caused by a plurality of conductions of the open driving current, thereby suppressing damage on the cutoff valve 45. Specifically, a conduction history used for prohibiting conduction through the cutoff valve 45 can be changed to any appropriate method by which conduction through the cutoff valve 45 can be prohibited before the cutoff valve 45 is damaged due to overheating. More specifically, instead of calculating an integrated value of the open driving current conduction period of time within the retroactive period, determining that a conduction frequency of the open driving current within the retroactive period is an upper limit frequency of more can be used for starting the conduction prohibiting process.

If the open driving current is conducted, the temperature of the cutoff valve 45 is increased largely. Thus, referring to a conduction frequency of the open driving current within the retroactive period makes it possible to see the frequency of occurrence of a situation where the temperature of the cutoff valve 45 is increased largely within the retroactive period. In this way, the temperature of the cutoff valve 45 can be estimated. Specifically, by starting the process of prohibiting conduction through the cutoff valve 45 on condition that the conduction frequency of the open driving current is the upper limit frequency of more, the situation where the temperature of the cutoff valve 45 is increased largely is determined to have occurred frequently and the temperature of the cutoff valve 45 can be estimated to be high. Starting the conduction prohibiting process in this case can suppress damage on the cutoff valve 45.

Conduction through the cutoff valve 45 may be prohibited if an integrated value of the value of a current flowing through the cutoff valve 45 within the retroactive period exceeds an upper limit.

Instead of finishing the conduction prohibiting process after a lapse of the specified period of time, the following condition may be used as a basis for removing a prohibition on conduction through the cutoff valve 45. For example, the conduction prohibiting process may be finished if operation in the first mode continues for a specified period of time or more.

The prohibition removing procedure shown in FIG. 4 intended to finish the conduction prohibiting process may be omitted. Specifically, even if a period when conduction is prohibited exceeds the specified period of time, a prohibition on conduction through the cutoff valve 45 is not required to be removed. In this case, after the conduction is prohibited once, the prohibition on the conduction may be removed during maintenance.

The technical idea of prohibiting conduction through the cutoff valve based on a conduction history of the open driving current can be applied widely to fuel supply devices including the cutoff valve. For a similar reason, a combination of fuel types to be supplied to a bi-fuel internal combustion engine by a fuel supply device is not limited to a combination of CNG and gasoline. The aforementioned technical idea is further applicable to a fuel supply device that supplies fuel to an internal combustion engine that selects fuel from two or more types and uses the selected fuel.

1. A fuel supply device comprising:
a fuel tank;
a fuel supply path through which fuel stored in the fuel tank is supplied;
an electric-operated cutoff valve located in the fuel supply path and opened in response to conduction through the cut-off valve; and
a controller that controls conduction through the cutoff valve, the controller opening the cutoff valve by conducting an open driving current through the cutoff valve, the open driving current being larger than a holding current of holding the cutoff valve in an open state,
wherein the controller implements a process of prohibiting conduction through the cutoff valve based on a conduction history of the open driving current through the cutoff valve within a retroactive period.

2. The fuel supply device according to claim 1, wherein the controller starts the process of prohibiting conduction through the cutoff valve on condition that an integrated value of an open driving current conduction period of time within the retroactive period is an upper limit or more.

3. The fuel supply device according to claim 1, wherein the controller starts the process of prohibiting conduction through the cutoff valve on condition that a conduction frequency of the open driving current within the retroactive period is an upper limit frequency of more.

4. The fuel supply device according to claim 1, wherein the controller finishes the process of prohibiting conduction through the cutoff valve on condition that a period when conduction through the cutoff valve is prohibited has continued for a specified period of time or more.

5. The fuel supply device according to claim 1, wherein
the fuel supply device is capable of changing fuel to be used, and
while the process of prohibiting conduction through the cutoff valve is implemented, the controller prohibits making a shift to a mode of using fuel to be supplied through the fuel supply path where the cutoff valve is located while conduction through the cutoff valve is prohibited.
